(19) United States
(12) Patent Application Publication
(10) Pub. No.: US 2004/0228948 A1
(43) Pub. Date: Nov. 18, 2004

(54) Increasing the concentration of conjugated linoleic acid isomers in the milk fat and/or tissue fat of ruminants

(76) Inventors: John J. Kennelly, Edmonton (CA); John A. Bell, Edmonton (CA)

Correspondence Address: Intellectual Property Department, DEWITT ROSS & STEVENS S.C., US Bank Building, 8000 Excelsior Drive Suite 401, Madison, WI, 53717-1914, US

(21) Appl. No.: 10/439,501

(22) Filed: May 16, 2003

(51) Int. Cl. A23D 7/00

(52) U.S. Cl. 426/2

(57) ABSTRACT

Disclosed are a feed formulation and a corresponding method of feeding ruminants. The formulation and method are preferably for use with lactating dairy cattle. The feed increases the concentration of conjugated linoleic acid isomers in the milk fat and/or tissue fat of ruminants. The feed includes a combination of safflower oil and monensin.

### BIBLIOGRAPHICAL REFERENCES

Full bibliographical citations for the references cited herein are contained in the Bibliography, immediately prior to the claims.

### FIELD OF THE INVENTION

This invention is directed to a feed formulation designed specifically to increase the concentration of conjugated linoleic acid isomers in the milk fat and/or tissue fat of ruminants in general and dairy cattle in particular.

### BACKGROUND

Conjugated linoleic acid (CLA) refers to a group of geometric and positional isomers of linoleic acid (cis-9, cis-12 octadecadienoic acid). Whereas linoleic acid has two cis double bonds on the 9^{th} and 12^{th} carbons, CLA has conjugated double bonds generally on the 9^{th} and 11^{th} or 10^{th} and 12^{th} positions. To maintain conjugation, these bonds can be in either the cis or trans geometry. The richest sources of CLA in the human diet are ruminant meat, milk, and milk products. Ongoing research suggests that CLA may have a range of beneficial effects on human health. Prominent among these beneficial effects are the potent anticarcinogenic properties of CLA (Parodi, 1997).

Most substances in nature that demonstrate anticarcinogenic activity are of plant origin and are only present in trace levels within their native plant sources (Wattenberg, 1992). In contrast, CLA is found almost exclusively in animal products. CLA has been shown to be one of the most potent of all naturally occurring anticarcinogens. The origins of research in this area can be traced to the much-cited studies from Michael Pariza's laboratory. While studying the effects of temperature and time on mutagen formation in pan-fried hamburger, Pariza et al. obtained evidence for mutagenic inhibitory activity in the uncooked and fried hamburger (Pariza et al., 1979). Pariza & Hargreaves (1985) subsequently partially purified the mutagenesis inhibitor from fried ground beef and showed that it was capable of inhibiting the initiation of mouse epidermal tumors by the mutagen 7,12-dimethylbenz[a]anthrazene (DMBA). This work was the first study to show that ground beef contained an anticarcinogen that was effective in an intact animal.

That cooked beef contained a substance that could inhibit tumor growth was intriguing because it was well known that the cooking of protein-rich foods can produce a range of mutagens and carcinogens (Dipple, 1983; Wakabayashi et al, 1992). It also raised the question of whether this was the reason for the lack of a strong association between the consumption of beef and other meats with certain types of cancer (Pariza and Hargreaves, 1985).

The next stage of the research was to elucidate the identity of the unknown anticarcinogen. Pariza & Hargreaves (1985) had earlier noted that the anticarcinogen was a very nonpolar molecule. Subsequent work from Pariza's laboratory showed that it was actually a mixture of four isomeric derivatives of linoleic acid, each isomer containing a conjugated double-bond system (Ha et al., 1987). The anticarcinogenic mixture was henceforth designated as CLA. To prove that the anticarcinogenic effects were indeed due to CLA, Ha et al. tested a synthetically prepared mixture of the CLA isomers on the mouse DMBA model. The CLA-treated mice developed only about one-half as many papillomas and exhibited a lower tumor incidence as compared to the control mice (Ha et al., 1987). This initial work started a cascade of research on CLA.

CLA has since been shown to be effective in experimental animal models of mouse skin carcinogenesis, mouse forestomach tumorigenesis, and rat mammary tumorigenesis (Belury, 1995; Ip, 1994). CLA was found to be effective in vitro against breast tumor cells (Shultz et al., 1992a), malignant melanoma and colorectal cancer cells (Shultz et al., 1992b), leukemia, prostate carcinoma, and ovarian carcinoma (Visonneau et al., 1996), and liver cancer (Yoon et al., 1997). CLA seems to act in a dose-dependent manner as demonstrated in vitro with breast cancer cells (Shultz et al., 1992a), and in vivo with DMBA-induced mammary tumors in rats (Ip et al., 1994). Feeding as little as 0.05 g CLA/100 g of diet caused a reduction in the number of mammary tumors (Ip et al., 1994).

Ip et al. (1999) evaluated the effect of CLA-enriched butter on mammary tumors in rats. The butter contained 4.1% CLA, 92% of which was the cis-9, trans-11 isomer. CLA enrichment was achieved by including sunflower oil in the diet of 20 dairy cows at 5.3% of dry matter. Milk was collected from nine of these cows that were producing the highest levels of CLA in their milk. It was shown that CLA-enriched butter was able to inhibit rat mammary tumor yield by 53%. This study clearly showed that the predominant isomer in ruminant products, the cis-9, trans-11 isomer, was anticarcinogenic.

Using direct extrapolation of studies with rats, Ip (1994) has estimated that an effective CLA intake for humans would be equivalent to an estimated average consumption of 3.5 g per day for a 70 kg person. Data on the relationship between CLA intake and risk of cancer in humans is not yet available. However, a Finnish National Public Health study covering a 25-year period indicated that as the intake of dairy products increased, the risk of breast cancer decreased (Knelkt, et al., 1996). This strongly suggests that there is a component or components in dairy products capable of affording significant benefits to human health.

Research also suggests that CLA may have a beneficial role in reducing atherosclerosis (Lee et al., 1994, Nicolosi et al., 1997); may have a benefit in diabetes treatment (Houseknecht et al., 1998); may reduce body fat and increase body protein in growing animals (Park et al., 1997); may counteract immune induced muscle wasting (Cook et al., 1993); and may improve bone formation (Watkins et al., 1999).

Meat from ruminants contains more CLA than meat from non-ruminants. Milk and other dairy products are also high in CLA, whereas vegetable oils and seafood are not. The amount of CLA found in whole milk is generally about 4.5 to 5.5 mg CLA/g fat (Lin et al., 1995; Ip, 1994), although Kelly et al. (1996) have observed variation in milk from New York herds that ranged from 2.4 to 18.0 mg CLA/g fat.

The cis-9, trans-11 is the most prevalent isomer and represents more than 90% of the CLA in milk and over 75% of the CLA in beef fat (Chin, et al. 1992). This isomer is thought to be the biologically active form (Ip, 1994; Belury, 1995; Kelly et al., 1996). Whether just one isomer is responsible for all of the diverse effects demonstrated is, however, as yet unresolved (McGuire et al., 1997). The CLA content of meat and dairy products is altered little by processing (Shantha et al., 1994, 1995). Thus, the concentration in prepared food products depends primarily upon the concentration in the raw material.

CLA is an intermediate product of rumen biohydrogenation of long-chain unsaturated fatty acids. Dietary fat is hydrolyzed by microbial lipases in the rumen and the resultant unsaturated fatty acids are subject to biohydrogenation by the rumen bacteria. Kepler & Tove (1967) showed that cis-9, trans-11 18:2, the major isomer of CLA, is the first intermediate formed in the biohydrogenation of linoleic acid by the rumen bacteria butyrivibrio. This initial reaction involves the isomerization of the cis-12 double bond to trans-11 by cis-12, trans-11 isomerase. This step occurs rapidly. The next step involves the conjugation of this diene to trans-11 monoene (t-11 18:1). This reaction occurs less rapidly. The complete hydrogenation of trans-11 18:1 to stearic acid (18:0) involves different organisms and is thought to be rate limiting (Griinari et al., 1997). Therefore, trans-11 typically accumulates in the rumen. Trans-11 18:1 and cis-9, trans-11 18:2 account for approximately 50% of the trans fatty acids found in milk fat (Griinari, 1998).

The rumen may not be the only origin of CLA production in the cow. Stearoyl-CoA desaturase (SCD) is capable of adding a cis-9 double bond to 18:0 (stearic acid) to produce 18:1 (oleic acid). This enzyme may also add a cis-9 to trans-11 18:1 (trans-vaccenic acid) producing CLA. Corl et al., (1998) infused either cis-18:1 or trans-18:1 into the abomasum of dairy cows and found that the level of CLA in the milk increased with the infusion of trans-18:1. Corl attributed this to the action of SCD on trans-11 18:1 in the mammary gland.

As it should be relatively easy to increase the ruminal production of this fatty acid, this may represent a means of significantly increasing the levels of CLA in milk. This would also lead to an increase in trans-11 18:1 in the milk. Although there is concern about trans fatty acids in the diet, there is evidence that trans-11 18:1 may actually have a benefit for health. Recent data by Salminen et al. (1998) suggest that trans-11 18:1 can be desaturated to CLA in human tissues. This may also explain the lack of correlation observed between trans fatty acids of animal origin and risk of coronary heart disease compared with trans fatty acids of vegetable origin, which showed a positive association (Willet et al., 1993). If CLA can indeed be produced by the action of SCD in the mammary gland, it may represent a significant route by which CLA can be synthesized for incorporation into milk fat.

McGuire et al. (1996) fed a diet containing varying levels of corn oil (55% linoleic acid) to cows and observed that the concentration of CLA in the cows' milk increased as dietary linoleic acid increased. However, the level of CLA at the highest dietary fat inclusion (7.2% ether extract) was only 6.94 mg CLA/g fat. Kelly et al. (1998) also showed that dietary fat high in linoleic acid increased the CLA content of milk. Kelly et al. supplemented the basal diet with 53 g/kg DM of peanut oil (high oleic acid), sunflower oil (high linoleic acid), or linseed oil (high linolenic acid). Resulting CLA concentrations were 13.3, 24.4, and 16.7 mg CLA/g milk fat, respectively. The increase in CLA levels observed with the sunflower oil treatment represented levels approximately 500% greater than those typically seen in traditional diets.

Chouinard et al. (1998) fed cows diets supplemented with 4% DM of calcium salts of fatty acids from canola oil, soybean oil, or linseed oil. The resulting milk CLA concentrations were 13.0, 22.0, 19.0 mg CLA/g fat for canola oil, soybean oil, and linseed oil, respectively, and 3.5 mg CLA/g fat for control. Soybean oil, which is high in linoleic acid, was most effective at increasing the CLA.

It should be noted that the level of CLA obtained in milk when using supplemental fat diets varies to a large extent depending on the ruminal conditions. For instance, a study at Cornell University using supplemental fat found that the CLA levels in milk were halved when the forage:concentrate ratio of the diet was changed from 50:50 to 20:80 (Kelly et al., 1996). Griinari et al. (1998) showed that high concentrate diets could alter the products of rumen biohydrogenation of polyunsaturated fatty acids, resulting in an increase in the proportion of trans-10 isomers. Therefore, the biohydrogenation of polyunsaturated fatty acids under conditions of high concentrate feeding may cause a change in rumen conditions leading to the formation of trans-10, cis-12 18:2 at the expense of cis-9, trans-11 18:2.

As used herein, the term “ionophore” refers to lipid-soluble antibiotics capable of disrupting the membrane potential of gram-positive bacteria, which leads to death of the gram-positive bacteria. Gram-positive bacteria tend to be the acetate- and hydrogen-formers in the rumen. In contrast, gram-negative bacteria, which are resistant to ionophores, produce propionate in the rumen. The use of ionophores in ruminates thus tends to increase the propionate to acetate ratio in the rumen, and reduces proteolysis and methane production in ruminants. For these reasons, ionophores are widely used in beef feed-lot operations because they improve production efficiency.

Ionophores also appear to interfere with the rumen biohydrogenation of polyunsaturated fatty acids, probably by inhibiting the growth of gram-positive bacteria. Fellner et al. (1997) studied the effects of ionophores on lipid biohydrogenation using a continuous culture system. They found that the antiporter ionophores monensin, nigericin, and tetronasin interfered with the biohydrogenation of linoleic acid. The study showed a reduction in the extent of linoleic acid biohydrogenation with an accumulation of the intermediate products of that process, including CLA.

This work was followed up by evaluating the ability of monensin at 24 mg/kg of dietary dry matter to increase milk CLA over a 28-day period in dairy cows (Sauer et al., 1998). A small but significant increase in CLA from 0.8% to 1.3% of milk fat was observed.

Other studies, however, have failed to show a benefit of ionophores for enriching the concentration of CLA in milk fat (Dhiman et al. 1999). The usefulness of ionophores to increase CLA in bovine milk is therefore considered equivocal. Furthermore, whether ionophores are effective over longer periods of time is also uncertain as the rumen has been known to adapt to the effects of ionophores (Griinari and Bauman, 1999).

### SUMMARY OF THE INVENTION

In view of the potential health benefits to be gained from human consumption of CLA in milk, the purpose of the present invention is to increase the concentration of CLA in ruminant (especially bovine) milk fat and/or tissue fat through manipulation of the animal's diet.

Thus, a first embodiment of the invention is directed to a method for increasing concentrations of conjugated linoleic acid isomers in milk fat and/or tissue fat of ruminants. The method comprises feeding a ruminant an amount of a feed formulation comprising a combination of: (a) a vegetable oil selected from the group consisting of vegetable oils containing at least 50%. C18:2, at least 30% C18:3, and mixtures thereof; and (b) an ionophore that inhibits growth of gram positive bacteria in a rumen. The feed formulation is fed in an amount effective to increase concentrations of conjugated linoleic acid isomers in the milk fat and/or tissue fat of ruminants.

It is preferred that the ruminant be fed a feed formulation comprising a combination of safflower oil and monensin.

A second embodiment of the invention is directed to a corresponding animal feed formulation. The feed formulation comprises combination of: (a) a vegetable oil selected from the group consisting of vegetable oils containing at least 50% C18:2, at least 30% C18:3, and mixtures thereof; and (b) an ionophore that inhibits growth of gram positive bacteria in a rumen. The combination is present in the feed formulation in an amount effective to increase concentrations of conjugated linoleic acid isomers in milk fat of ruminants when the feed formulation is fed to a ruminant.

It is preferred that the feed formulation comprises safflower oil and monensin, the combination being present in the feed formulation in an amount effective to increase concentrations of conjugated linoleic acid isomers in milk fat of ruminants when the feed formulation is fed to a ruminant.

Advantageously, the present invention produces CLA-enriched milk and meat. The feed formulation of the present invention enriches the concentration of CLA isomers (mainly cis-9, trans-11 18:2) in bovine milk fat by as much as 10 to 15 times normal levels (from approximately 0.5% to approximately 5.6%). Because CLA is a potent anticarcinogen, CLA-enriched milk could have significant benefits for the health of the consumer.

Furthermore, the same inventive method described herein, that increases CLA in mile, also produces the additional benefit of an overall reduction in saturated fatty acids in milk.

The feed formulation of the present invention results in greater CLA enrichment of milk fat than has been achieved previously. The reasons for this are believed to be two-fold: (1) The method uses oil from oilseeds that increase the rumen production of CLA or trans-11 18:1 (a precursor for CLA production in the ruminant mammary gland). Safflower oil is particularly effective in this regard. (2) The method uses ionophores, which interfere with the biohydrogenation process, thus resulting in an increased production of CLA and/or trans-11 18:1 in the rumen. Monensin is particularly effective in this regard.

The use of both these factors in combination, and included in the dairy diet at relatively high levels, is believed to be the primary reason for the degree of CLA enrichment achieved.

There are several aspects of the presently disclosed feed formulation that makes it an improvement over existing technology. It includes a combination of oil from oilseeds that are high in C18:2 or C18:3 (e.g., safflower) at a high level of inclusion in the dairy diet (e.g., the preferred level being about 6% of dietary dry matter), along with the inclusion of an ionophore (e.g., monensin) at up to 22 mg/kg dry matter. The combined effects of these two dietary ingredients make this formulation particularly effective at increasing the CLA levels in milk.

The feed formulation itself is a product that could be produced by feed companies supplying the dairy industry. CLA-enriched milk and/or products derived from that milk such as CLA-enriched cheese and butter are the end products resulting from this technology.

### BRIEF DESCRIPTION OF THE FIGURES

FIG. 1 is a graph depicting the average vitamin E content of milk (microgram alpha-tocopherol/g milk) of treatment groups at weeks 0, 2, 4, 8. See Example 2.

FIG. 2 is a graph depicting average content of 18:2 (n-6%) in milk of treatment groups at weeks 0, 2, 4, 8. See Example 2.

FIG. 3 is a graph depicting Average milk 18:3 content (n-3%) of treatment groups at weeks 0, 2, 4, 8. See Example 2.

FIG. 4 is a graph depicting average milk percentage of cis-9, trans-11, and CLA of treatment groups at weeks 0, 2, 4, 8. See Example 2.

FIG. 5 is a graph depicting average milk content 18:1 trans % of treatment groups at weeks 0, 2, 4, 8. See Example 2.

FIG. 6 is a graph depicting average milk content 16:0% of treatment groups at weeks 0, 2, 4, 8. See Example 2.

FIG. 7 is a graph depicting average milk content 14:0% of treatment groups at weeks 0, 2, 4, 8. See Example 2.

### DETAILED DESCRIPTION OF THE INVENTION

The present invention contemplates adding the feed formulation of the present invention in combination with a conventional fodder. The formulation is added to the fodder in an amount to increase CLA concentration in the milk and/or tissue fat of ruminant animals, preferably bovines.

Fodder:

The base feed or fodder typically comprises alfalfa hay, alfalfa silage, small grain silages (e.g., barley or triticale silage), grass, barley, corn, oats, sorghum, wheat, bran, hominy and mixtures thereof. (For a list of the preferred basal feed, see Table 1). The base feed for dairy cows is made up of two parts (forage and concentrate) that are combined to give a Total-Mixed-Ration (TMR). The forage may include but is not limited to: alfalfa hay, alfalfa silage, small grain silage (e.g., barley or triticale silage), grass, and hay. The concentrate may include but is not limited to: corn, barley, oats, sorghum, wheat, bran and hominy, protein rich supplements (e.g., soybean meal, canola meal, bloodmeal, corn gluten), vitamins and minerals.

The supplemental oils contemplated by the subject invention generally make up a portion of the concentrate. The dairy diet is formulated to meet National Research Council (NRC) recommendations for lactating cows. These recommendations ensure that a formulated diet will contain adequate energy, protein, fiber, vitamins, and minerals to meet the nutritional requirements of the animal.

Safflower Oil:

Safflower oil is more effective at increasing the CLA concentration in milk than other oilseeds like soybean, sunflower, and canola, most likely because it has a higher content of the precursor molecule, linoleic acid. However, other oilseeds that have a high content (over 50%) of C18:2 or high content (over 30%) of C18:3 can be used instead of safflower. The oils generally are added in an amount between about 2% and 7% by weight of the dietary dry matter. Levels of at least 6% by weight will have the greatest effect in terms of increasing the concentration of CLA in bovine milk.

Monensin and Other Ionophores:

Monensin is an ionophore antibiotic that selectively inhibits the growth of certain types of bacteria in the rumen. The systematic name for monensin is 2-{5-Ethyltetrahydro-5-{tetrahydro-3-methyl-5-{tetrahydro-6-hydroxy-6-hydroxymethyl)-3,5-dimethyl-2H-pyran-2-yl}-2-furyl-9-hydroxy-beta-methoxy-alpha,gamma,2,8-tetramethyl-1,6-dioxaspiro{4.5}decane-7-butyric acid; CAS No. 17090-79-8. The changes brought about in the bacterial population result in a reduction in the rate at which C18:2 and C18:3 is hydrogenated in the rumen. As a consequence, more CLA and C18:1 trans-11 (trans-vaccenic acid) escape hydrogenation, thus resulting in higher levels of CLA in the milk fat. Although monensin is highly effective and preferred, any type of ionophore that selectively inhibits the growth of gram-positive bacteria in the rumen can also be used, e.g., nigericin (CAS No. 28280-24-7), tetronasin. All are available commercially from numerous international sources, such as Serva Electrophoresis GmbH, Heidelberg, Germany (formerly a subsidiary of Invitrogen Corporation, and spun-out as a wholly independent company in July 2002).

The preferred level of ionophore is 22 mg/kg of dietary dry matter or at a level up to the current maximum allowable level (currently 22 mg/kg).

Manner of Mixing:

Another aspect that was important in determining the success of the present feed formulation was the manner in which the safflower oil and monensin was mixed into the diet. The safflower oil and monensin are preferably pre-mixed into the concentrate part of the ration. The concentrate including the feed formulation was then mixed with the forage immediately prior to feeding. Pre-mixing the oil into the concentrate portion of the ration allows the oil to become coated on the surface of the concentrate instead of coating the forage.

Forage to Concentrate Ratio:

In addition, the forage to concentrate ratio is important to the success of the formulation. The total mixed ration (TMR) preferably comprises about a 60:40 mix of forage to concentrate. Research in the past has recommended that oils high in polyunsaturates not be used in dairy rations at levels above 2-3% DM. Feeding higher levels was reported to have negative impact on rumen fermentation, especially fiber digestion, leading to a decrease in feed intake and productivity. Pre-mixing the high levels of oil into the concentrate and mixing that concentrate into a ration that included 60% forage enables higher levels of oil to be fed with the ration, without a negative impact on the rumen environment. Although a 60:40 forage:concentrate ratio may be optimal, a range of forage levels (between about 35% and about 75%) can be used. The feed formulation as part of a concentrate-feed could also be used in pasture feeding situations as a supplement to the pasture.

Optional Ingredients:

In addition to the above-listed ingredients, other ingredients can be incorporated into the feed formulation. Such ingredients can be selected from a wide variety of nutritional supplements and medicaments, including the following:

C₂-C₂₂ aliphatic carboxylic acids, and alkali metal, ammonium, and alkaline earth metal salts, which can be different or correspond in size with the other fatty acid constituents present in the aliphatic amide ingredients.

Sugars and complex carbohydrates, including both water-soluble and water-insoluble monosaccharides, disaccharides, and polysaccharides. Cane molasses, for example, is a byproduct from the extraction of sucrose from sugar cane. It is commercially available at standard 79.5 Brix concentration, and has a water content of about 21 wt %, and a sugar content of 50 wt %. Sugar beet byproducts also are available as low cost carbohydrate sources.

Another suitable source of complex carbohydrates is whey. Whey is a byproduct of the dairy industry. Whey is a dilute solution of lactalbumin, lactose, fats, and the soluble inorganic matter from milk. Dried whey solids typically have the following composition:

Protein 12.0%

Fat 0.7%

Lactose 60.0%

Phosphorus 0.79%

Calcium 0.874

Ash 9.7%

Another source of carbohydrate is derived from the pulp and paper industry, which produces large quantities of lignin sulfonates from wood during the sulfite pulping process. This carbohydrate by-product is a constituent of the spent sulfite liquor.

Amino acid ingredients, either singly or in combination, including arginine, histidine, isoleucine, leucine, lysine, methionine, phenylalanine, threonine, tryptophan, valine, tyrosine ethyl HCl, alanine, aspartic acid, sodium glutamate, glycine, proline, serine, cysteine ethyl HCl, and the like, and analogs and salts thereof.

Vitamin ingredients, either singly or in combination, including thiamine HCl, riboflavin, pyridoxine HCl, niacin, niacinamide, inositol, choline chloride, calcium pantothenate, biotin, folio acid, ascorbic acid, vitamin B₁₂, p-aminobenzoic acid, vitamin A acetate, vitamin K, vitamin D, vitamin E, and the like.

Trace element ingredients include compounds of cobalt, copper, manganese, iron, zinc, tin, nickel, chromium, molybdenum, iodine, chlorine, silicon, vanadium, selenium, calcium, magnesium, sodium and potassium.

Protein ingredients as obtained from sources such as dried blood or meat meal, dried and sterilized animal and poultry manure, fish meal, liquid or powdered egg, fish solubles, cell cream, soybean meal, cottonseed meal, canola meal, and the like.

Protein equivalent ingredients include non-protein nitrogen compounds such as urea, biuret, ammonium phosphate, and the like.

Medicament ingredients either singly or in combination, including promazine hydrochloride, chloromadionate acetate, chlortetracycline, sulfamethazine, poloxaline, and the like. Oxytetracycline is a preferred antibiotic for cattle prophylaxis.

Antioxidants, such as butylated hydroxyanisole, butylated hydroxytoluene, tocopherol, tertiary-butylhydroquinone, propyl gallate, and ethoxyquin; and-suitable preservatives include sodium sorbate, potassium sorbate, sodium benzoate, propionic acid, .alpha.-hydroxybutyric acid, and the like.

Suspension stabilizing agents, such as nonionic surfactants, hydrocolloids and cellulose ethers. These types of chemical agents are illustrated by polyethylene oxide condensates of phenols, C₈-C₂₂ alcohols and amines; ethylene oxide reaction products with fatty acid partial esters of hexitans; alkylarylpolyoxyethylene glycol phosphate esters; gum arabic; carob bean gum; tragacanth gum; ammonium, sodium, potassium and calcium alginates; glycol alginates; xanthan gum; potato agar; alkylcellulose; hydroxyalkylcellulose; carboxyalkylcellulose; and the like.

### EXAMPLES

The following Examples are included solely to provide a more complete description of the invention disclosed and claimed herein. The Examples do not limit the scope of the claimed invention in any fashion.

### Example 1

Methods and Materials for Example 1:

Twenty-eight lactating Holstein cows were blocked according to parity and days-in-milk (DIM) to give seven blocks with four cows per block. Cows within each block were randomly assigned to one of the four dietary treatments: (1) Control (CTL); (2) Control including monensin at 24 mg/kg of dietary dry matter (MON); (3) Control including safflower oil at 6% of dietary dry matter (SAFF); (4) Control including 24 mg/kg monensin plus 6% safflower oil (SM). Table 1 shows the detailed composition of each diet.

TABLE 1
Ration composition for each treatment (% Dry Matter)

| | CTL | MON | SAFF | SM |
|---|---|---|---|---|
| Forage: | | | | |
| Alfalfa Hay (Mid | 10 | 10 | 10 | 10 |
| Bloom) | | | | |
| Barley Silage | 25 | 25 | 25 | 25 |
| Alfalfa Silage | 25 | 25 | 25 | 25 |
| Concentrate: | | | | |
| Barley Grain | 10.4 | 10.4 | 10.4 | 10.4 |
| Corn Grain (Cracked) | 20.5 | 20 | 13 | 12.5 |
| Soy 48 (Soybean meal) | 7 | 7 | 8.5 | 8.5 |
| Safflower Oil | 0 | 0 | 6 | 6 |
| Monensin | 0 | 0.54 | 0 | 0.54 |
| Salt | 0.2 | 0.16 | 0.2 | 0.16 |
| Vitamins ADE | 0.07 | 0.07 | 0.07 | 0.07 |
| Mineral Mix | 0.4 | 0.4 | 0.4 | 0.4 |
| Magnesium Oxide | 0.28 | 0.28 | 0.28 | 0.28 |
| Sodium Bicarbonate | 0.15 | 0.15 | 0.15 | 0.15 |
| Dicalcium Phosphate | 0.15 | 0.15 | 0.15 | 0.15 |
| Biofos | 0.25 | 0.25 | 0.25 | 0.25 |
| Limestone | 0.6 | 0.6 | 0.6 | 0.6 |

TABLE 2
ACTUAL chemical composition

| Chemical | | | | |
|---|---|---|---|---|
| composition | CTL | MON | SAFF | SAFF/M |
| DM, % | 44.7 | 44.7 | 45.2 | 45.8 |
| CP | 17.3 | 17.3 | 17.0 | 16.9 |
| Crude fat | 4.34 | 4.51 | 7.74 | 7.58 |
| NDF | 44.1 | 45.1 | 46.7 | 48.0 |
| ADF | 24.8 | 26.6 | 27.9 | 27.9 |
| Ash | 10.3 | 10.4 | 9.9 | 10.1 |

The cows were fed the dietary treatments for 15 days. Prior to receiving the four dietary treatments all cows received the control treatment for eight days as a covariate. During the first three days of the covariate period and the treatment period the cows were adjusted gradually to the new diets.

Cows were fed treatments as a total mixed ration (TMR) once daily at approximately 10 am. The intake of each cow was recorded daily and samples of the complete feed, individual ingredients, and orts (the feed left-overs) were collected twice weekly for analysis. All cows were weighed and body condition scored (five-point scale) at the end of the covariate period and the end of the treatment period. Cows were milked twice daily at 4 am and 4 pm. Milk was sampled on the last two days of the covariate and treatment periods. On each sampling day the AM and PM milk from each cow was pooled to give one representative sample from each cow for the day. Milk was analyzed for percentage of fat, protein, and lactose and somatic cell count (Dairy Herd Improvement Central Milk Testing Laboratories). Milk was also analyzed for fatty acid composition using gas chromatography.

Results and Discussion for Example 1:

As illustrated in Table 3, milk yield was not significantly different between treatments.

TABLE 3
Yield of milk, percentage and yield of fat, protein, and lactose.

| | CTL | MON | SAFF | SM |
|---|---|---|---|---|
| Milk yield | 26.87^{a} | 27.58^{a} | 26.78^{a} | 27.82^{a} |
| kg/day* | | | | |
| Fat % # | 4.01^{a} | 3.57^{b} | 2.83^{c} | 2.95^{c} |
| Fat yield kg/day | 1.05^{a} | 0.97^{a} | 0.75^{b} | 0.81^{b} |
| Protein % | 3.33^{a} | 3.37^{a} | 3.11^{a} | 3.23^{a} |
| Protein yeild | 0.87^{a} | 0.92^{a} | 0.82^{a} | 0.88^{a} |
| kg/day | | | | |
| Lactose % | 4.3^{ab} | 4.54^{a} | 4.26^{b} | 4.50^{ab} |
| Lactose yield | 1.13^{a} | 1.24^{a} | 1.14^{a} | 1.24^{a} |
| kg/day | | | | |

Within a row, values with different superscripts are significantly different (P < 0.05).
*Average milk yield over the last eight days of the treatment period.
#Values for fat, protein, and lactose represent average values for milk taken from the last two days of the treatment period.

The percentage and yield of lactose and protein were in the typical range for Holstein cows, although treatments that included monensin (MON and SM) tended to have a higher lactose percentage. The percentage of fat was significantly reduced with the MON, SAFF, and SM treatments compared to CTL. The decrease in milk fat percentage was greatest in the treatments that included safflower oil (SAFF and SM). Although there was a significant decrease with monensin alone, the combination of safflower oil and monensin did not depress milk fat more than what was observed with safflower alone. There is strong evidence that trans-fatty acids produced in the rumen biohydrogenation process have a milk fat depressing effect (Griinari et al. 1998). This is likely the reason for the decrease in milk fat percentage observed in this study.

The CTL diet, representative of diets fed in Alberta, resulted in milk fat with a CLA (cis-9, trans-11 isomer) concentration of 0.45%, similar to that typically reported for whole milk (Table 4). Cows fed the SM diet produced milk fat with 5.15% CLA, approximately 12 times greater than the CTL diet. Even though the percentage of fat was lower for the SM treatment (2.95%) compared to CTL (4.01%), the yield of CLA was still approximately nine times higher for SM compared to CTL as illustrated in Table 4.

TABLE 4

| | Treatments¹ | | | | |
|---|---|---|---|---|---|
| Fatty acid² | CTL | MON | SAFF | SAFF/M | sem |
| 4:0 | 5.17^{a} | 4.82^{a} | 5.08^{a} | 4.06^{b} | 0.200 |
| 6:0 | 3.38^{a} | 3.20^{a} | 2.48^{b} | 2.14^{b} | 0.120 |
| 8:0 | 1.98^{a} | 1.87^{a} | 1.24^{b} | 1.13^{b} | 0.064 |
| 10:0 | 4.23^{a} | 4.20^{a} | 2.18^{b} | 2.06^{b} | 0.154 |
| 11:0 | 0.65^{a} | 0.61^{a} | 0.26^{b} | 0.23^{b} | 0.027 |
| 12:0 | 4.80^{a} | 4.79^{a} | 2.44^{b} | 2.40^{b} | 0.130 |
| 13:0 | 0.25^{a} | 0.31^{b} | 0.14^{c} | 0.15^{c} | 0.017 |
| 14:0 | 13.78^{a} | 14.17^{a} | 9.09^{b} | 9.16^{b} | 0.232 |
| 14:1 | 1.36^{ad} | 1.44^{ac} | 0.84^{b} | 1.01^{bd} | 0.121 |
| 15:0 | 1.68^{a} | 1.92^{b} | 0.97^{c} | 0.98^{c} | 0.055 |
| 16:0 | 33.36^{a} | 32.25^{a} | 18.90^{b} | 18.66^{b} | 0.900 |
| 16:1 n-7 | 1.87^{a} | 1.96^{a} | 1.11^{b} | 1.20^{b} | 0.166 |
| 18:0 | 5.73^{a} | 5.21^{a} | 8.98^{b} | 8.02^{b} | 0.360 |
| 18:1 trans | 1.40^{a} | 1.54^{a} | 9.56^{b} | 13.53^{c} | 0.760 |
| 18:1 n-12 | 0.71^{a} | 0.96^{a} | 1.88^{b} | 1.50^{c} | 0.091 |
| 18:1 n-9 | 11.59^{a} | 12.05^{a} | 18.47^{b} | 16.72^{c} | 0.474 |
| 18:1 n-7 | 0.61^{a} | 0.63^{a} | 0.86^{b} | 0.83^{b} | 0.024 |
| 18:2 t-11c-15 | 0.16^{a} | 0.18^{a} | 0.42^{b} | 0.40^{b} | 0.010 |
| 18:2 n-6 | 1.38^{a} | 1.49^{a} | 2.69^{b} | 2.58^{b} | 0.082 |
| 18:3 n-3 | 0.39^{ab} | 0.41^{a} | 0.35^{bc} | 0.34^{c} | 0.015 |
| 20:0 | 0.12^{a} | 0.11^{a} | 0.15^{b} | 0.14^{ab} | 0.008 |
| 20:1 n-12 | 0.10 | 0.11 | 0.12 | 0.11 | 0.006 |
| 20:1 n-9 | 0.03^{a} | 0.03^{a} | 0.06^{b} | 0.07^{c} | 0.003 |
| CLA c-9, t-11 | 0.45^{a} | 0.52^{a} | 3.36^{b} | 5.15^{c} | 0.232 |
| CLA t-10, c-12 | nd^{a} | nd^{a} | 0.05^{b} | 0.08^{c} | 0.006 |
| CLA trans/trans | 0.03^{a} | 0.04^{a} | 0.13^{b} | 0.15^{b} | 0.008 |
| Other FA | 4.78^{a} | 5.18^{a} | 8.18^{b} | 7.17^{c} | 0.162 |
| CLA c-9, t-11 | 4.70^{a} | 4.95^{a} | 25.79^{b} | 41.97^{c} | 3.226 |

^{a,b,c}Within a row, values with different superscripts are significantly different (P < 0.05).
¹Diets were control (CTL), and control supplemented with, monensin (Mon), safflower oil (SAFF), safflower oil plus monensin (SAFF/M).
²All values presented as percentage of fatty acid methyl esters.
nd = Not detected

The SM diet also increased the percentage of the trans-10, cis-12 and trans, trans CLA isomers as well as C18:2 (linoleic), C18:1 cis-9 (oleic), trans-11 18:1 (trans-vaccenic), C18:0 (stearic), and decreased the percentage of short and medium chain fatty acids (C4:0-C16:0).

Safflower oil contains approximately 76% linoleic acid. Since CLA and trans-11 18:1 are intermediate products in the biohydrogenation of linoleic acid (C18:2), the addition of safflower oil would be expected to increase the level of these isomers in the milk. A certain amount of the linoleic acid would likely escape biohydrogenation, which would explain the increase in linoleic acid with the SM treatment. Furthermore, some of the linoleic acid would have been completely hydrogenated to C18:0, which also explains the higher stearic acid concentration observed with the SM treatment. The inclusion of safflower oil (SAFF and SM) also resulted in a significant increase in trans-10, cis-12 CLA and the trans, trans CLA isomers compared to CTL or MON. These CLA isomers are also produced in the rumen through the action of microbial enzymes but only represent aminor proportion of the total CLA in bovine milk.

Fellner (1997) showed that monensin could reduce the rate of linoleic acid biohydrogenation resulting in an accumulation of trans fatty acids, including CLA. The MON treatment did tend to increase the percentage of trans-11 18:1 and CLA compared to CTL, although this was not significant. The benefit of monensin was more clearly demonstrated when it was combined with safflower oil. The SM compared to SAFF had a higher concentration of trans-11 18:1 and CLA, and a lower concentration of C18:0.

Overall, the SAFF and SM diets changed the composition of the milk in a number of ways that may have benefits to the health of the consumer. The increase in CLA may have substantial benefits to the health of the consumer. Feeding CLA enriched butter to rats reduced the mammary tumor yield by 53% (Ip et al., 1999). It is therefore possible that human consumption of CLA enriched milk or products derived from that milk could play a role in the prevention of certain types of cancer. The SAFF and SM diets resulted in a significant increase in trans-11 18:1 compared to CTL or MON. Although there are concerns about the level of trans fatty acids in the human diet, there is evidence that trans-11 18:1 can be desaturated to cis-9, trans-11 CLA in human tissues. The SAFF and SM milk compared to CTL or MON had approximately 41.44% lower C16:0, 33-35% lower C14:0, and approximately 50% higher cis-9 18:1. Consumption of milk with lower C16:0 and C14:0 and higher cis-9 18:1 as in SAFF and SM could have a positive effect on plasma cholesterol levels compared to CTL milk.

These results demonstrate the feasibility of producing CLA enriched milk. Furthermore, the same treatments that increased CLA also produced the additional benefit of an overall reduction in saturated fatty acids and an increase in unsaturated fatty acids.

### Example 2

The results presented in Example 1 demonstrate the ability of safflower oil in combination with monensin to significantly increase the concentration of conjugated linoleic acid isomers in bovine milk fat. This Example 2 was carried out to confirm, and more thoroughly explore, these results found in Example 1. The specific objectives of this Example were:

To confirm that safflower oil (6% of DM) with monensin (24 ppm) is more effective at increasing CLA in bovine milk than safflower alone.

To determine if the monensin effect would be maintained over a period of two months (compared with two weeks in Example 1).

To determine the effect of supplemental vitamin E (150 IU/kg DM) on milk CLA and oxidative stability.

To evaluate the ability of flaxseed oil to increase milk CLA.

To carry out a complete sensory evaluation of the CLA-enriched milk.

Materials and Methods for Example 2:

All procedures involving the use of animals were approved by the Faculty Animal Policy and Welfare Committee at the University of Alberta. Twenty-eight primiparous and 34 multiparous lactating Holstein cows were used in a randomized complete block design with repeated measures. Animals were blocked according to parity and DIM. Cows within each block were then randomly assigned to one of six treatment diets: (1) Control diet (CTL); (2) Control diet including safflower oil supplemented at 6% of DM (SAFF); (3) Control diet including safflower oil supplemented at 6% of DM plus Vitamin E supplemented at 150 IU/kg DM (SAFF/E); (4) Control diet including safflower oil supplemented at 6% of DM plus monensin supplemented at 24 ppm of DM (SAFF/M); (5) Control diet including safflower oil supplemented at 6% of DM plus Vitamin E supplemented at 150 IU/kg DM plus monensin supplemented at 24 ppm of DM (SAFF/M/E); (6) Control diet including flaxseed oil supplemented at 6% of DM plus Vitamin E supplemented at 150 IU/kg DM (FLAX/E). The supplementary ingredients were added to their respective concentrates prior to addition of forages by thorough mixing in Calan data rangers in 500 kg batches. All diets were formulated to meet or exceed NRC recommendations (NRC, 1989).

Cows were housed in tie-stalls with water available at all times. The diets were fed once per day at nine AM as a TMR consisting of 60% forage and 40% concentrate (Table 5). Feed intake was recorded daily and adjusted to maintain 5 to 10% orts. The CTL diet was fed initially to all cows for 10 days (week 0). Cows then received their predetermined diets for a period of nine weeks. Cows were adapted to dietary change over a three-day period. Milking was carried out twice per day starting at 0330 and 1430. Milk yield was recorded daily. Milk was sampled from each cow at AM and PM milking on the last day of weeks 0, 2, 4, and 8. The amount sampled at each milking was proportional to the milk yield. The AM and PM samples were then combined to give one sample for each cow at each time point. A portion of milk from each cow was preserved with potassium dichromate and analyzed for protein, fat, lactose, and somatic cell count at the Alberta Agriculture, Food and Rural Development Central Milk Testing Laboratory (Edmonton, Alberta, Canada). The rest of the milk was stored at −20° C. until analysis of fatty acid composition and vitamin E content.

Milk for trained sensory evaluation was collected on the third-last day and last day of weeks 0, 2, 4, and 8. The milk was standardized, pasteurized and homogenized prior to sensory evaluation. The evaluation was carried out after 0 and 5 days storage at 4° C. after processing. Ten trained panelists evaluated each milk sample for odor (overall intensity and off-odor intensity), flavor (overall intensity, off-flavor intensity, sweetness, aftertaste) and mouthfeel, and could also assign a score for particular off-flavor attributes such as flat, oxidized, acid, rancid/bitter, malty, feed, and salty. Processing and sensory evaluation was carried out at the Alberta Agriculture, Food and Rural Development Centre in Leduc, Alberta.

The data were analyzed as a randomized complete block design with repeated measures using MIXED procedure of SAS version 8:3 (SAS Institute, Cary, N.C.).

Results and Discussion for Example 2:

The fatty acid compositions of the safflower and flaxseed oils are presented in Table 6. These oils were chosen for their high content of polyunsaturated fatty acids. Safflower is particularly high in 18:2 n-6 (76%) whereas flaxseed oil is high in 18:3 n-3 (41.7%) with lower levels of 18:2 n-6 (21.3%). In the rumen 18:2 n-6 can be converted to CLA and trans-11 18:1, whereas 18:3 n-3 appears to be converted to trans-11 18:1 but not CLA. Since the trans-11 18:1 can be converted to CLA in the mammary gland feeding oils high in 18:2 n-6 or 18:3 n-3 could potentially increase the level of CLA in milk.

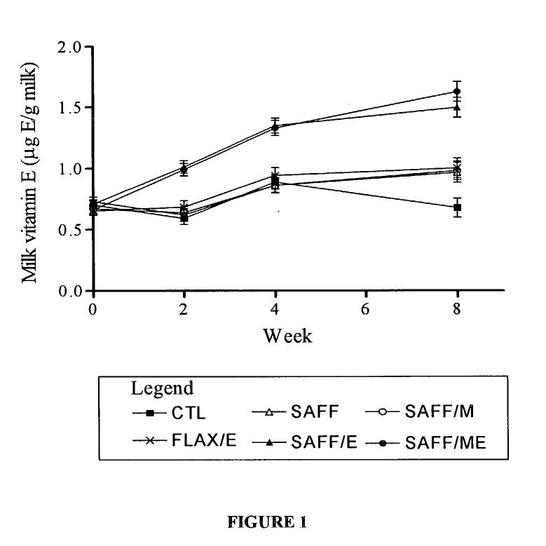

Dry matter intake, milk yield and milk composition is shown in Table 7. There was no significant difference in dry matter intake, milk yield, or concentration of milk lactose and protein during the treatment period. The SAFF and SAFF/M milk had significantly lower milk fat percentages compared to CTL. The addition of polyunsaturated fatty acids (PUFA) to the dairy diet is commonly found to cause a depression in milk fat percentage. This is believed to be due to the production of certain trans fatty acids from PUFA in the rumen that inhibit milk fat synthesis in the mammary gland. The addition of vitamin E appeared to partially protect against this depression in milk fat since SAFF/E and SAFF/ME were not significantly different from CTL. The milk fat percentage was also not significantly different for FLAX/E compared to CTL. This effect of vitamin E on bovine milk fat has been observed by other laboratories. The vitamin E content of milk was significantly higher for SAFF/E and SAFF/ME compared to all other treatments (Table 7, FIG. 1). The supplementation of vitamin E was expected to increase the level of vitamin E in the milk even though the transfer efficiency from diet to milk is known to be relatively low in cows. It is not certain why the addition of vitamin E to the diet containing flaxseed oil did not also result in an increase in vitamin E in FLAX/E milk, even though this diet had levels of vitamin E similar to SAFF/E and SAFF/ME.

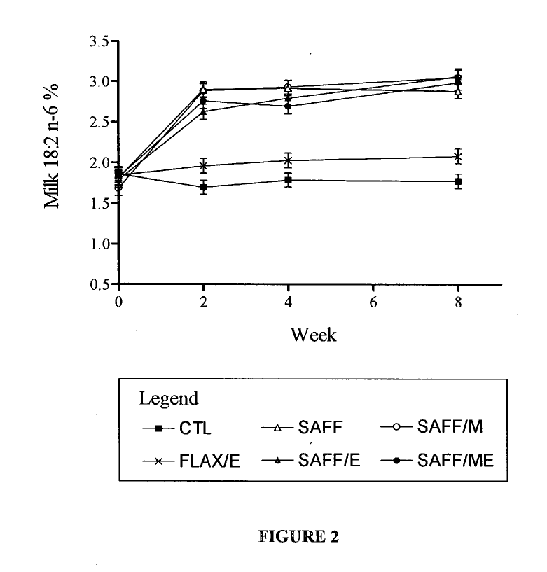

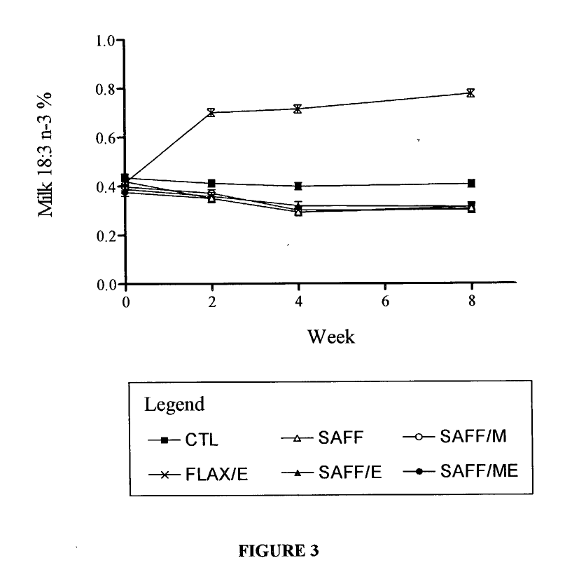

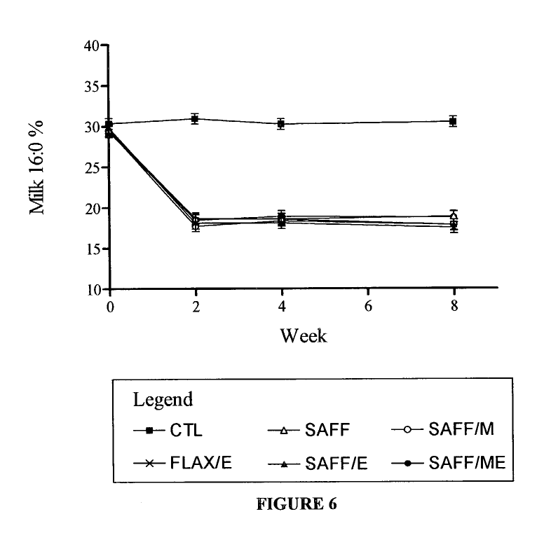

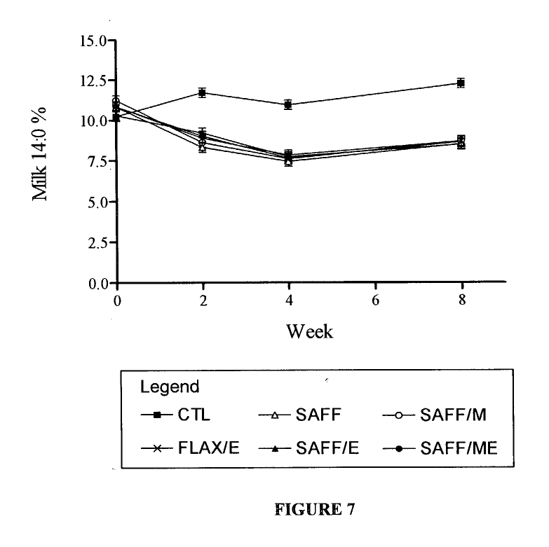

The effect of dietary treatment on milk fatty acid composition is shown in Table 8 and FIGS. 2-7. The main characteristics of the safflower oil and flaxseed oil were to some extent reflected in the milk fatty acid composition. The addition of safflower or flaxseed oil significantly raised the level of 18:2 n-6 in the milk compared to CTL (Table 8, FIG. 2), although this was much more pronounced for the safflower diets compared to the flaxseed. The addition of flaxseed to the diet increased the level of 18:3 n-3 in milk compared to CTL or safflower treatments (Table 8, FIG. 3). Although a significant increase in 18:2 n-6 and 18:3 was observed in the milk the overall transfer efficiency of these fatty acids from diet to milk was relatively low, most likely due to biohydrogenation in the rumen.

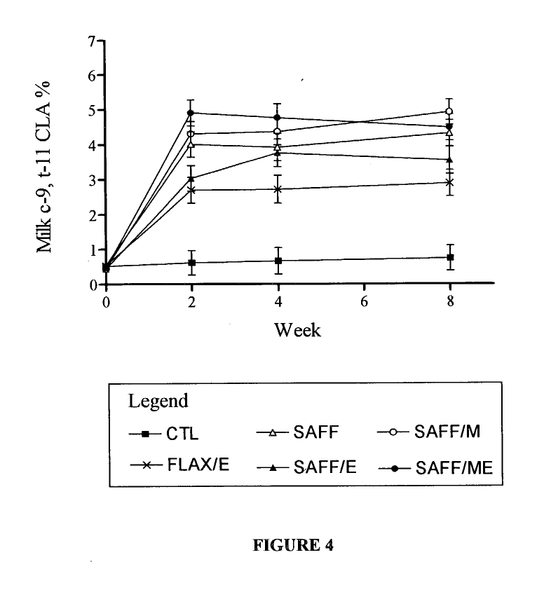

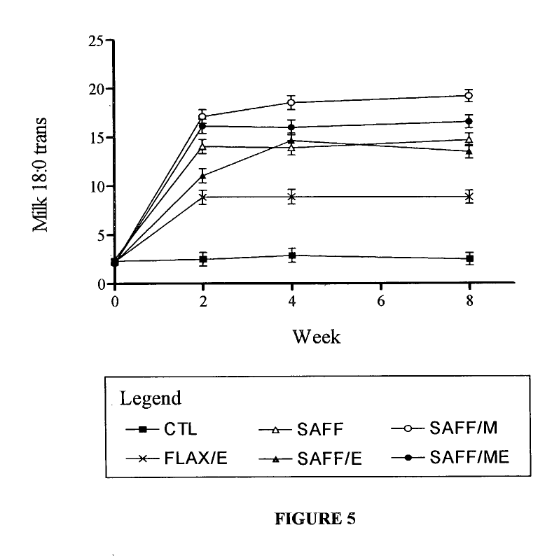

The rumen biohydrogenation process produces CLA and trans-11 18:1 as intermediate products. Moreover, as noted earlier the trans-11 18:1 can be converted to cis-9, trans-11 CLA in the mammary gland. The level of both CLA and total trans 18:1 fatty acids were significantly increased in milk with all safflower and flaxseed treatments compared to CTL (Table 8, FIGS. 4 and 5). The safflower oil was more effective than flaxseed oil at increasing the level of CLA in milk.

Within the safflower treatments, the two diets containing monensin (SAFF/M and SAFF/ME) had numerically higher levels of CLA in milk compared to the two diets not containing monensin (SAFF and SAFF/E). This difference was significant for SAFF/E compared to SAFF/M or SAFF/ME but was not significant for SAFF compared to SAFF/M or SAFF/ME. In the previous Example the difference between safflower and safflower plus monensin was found to be statistically significant. A reason why it is not significant in this study may be because of the amount of animal variation in the SAFF/M group in this study as two cows in this group appeared to have levels of CLA substantially below that of the rest of the SAFF/M group. The effect of monensin was more clearly observed in trans 18:1. The SAFF/M and SAFF/ME groups had significantly higher trans 18:1 in the milk compared to the SAFF and SAFF/E groups (Table 8). This suggests that the variation in CLA between animals noticed in the SAFF/M group might be in the ability of the mammary gland to convert trans-11 18:1 to CLA. The variation between individual animals within the same treatment group is interesting and worthy of further study. It can also be seen from FIGS. 4 and 5 that the effect of monensin on CLA and trans 18:1 was consistent across the two-month period.

It has already been noted that the vitamin E partially prevented the depression in milk fat compared to the same treatments without vitamin E., The reason for this may be due to an effect on the rumen biohydrogenation pathways resulting in a change in the types of trans fatty acids synthesized, or in the overall quantity of trans fatty acids produced. The results of Table 8 provide evidence at least for the latter theory. The milk content of trans 18:1 is numerically lower for SAFF/E compared to SAFF, and significantly lower for SAFF/ME compared to SAFF/M. An effect of vitamin E on trans 18:1 production in the rumen could decrease milk CLA content either through a reduction in the amount of trans-11 18:1 available for CLA synthesis in the mammary gland, or by a dilution of milk CLA because of the higher fat yield. However, since the values for milk CLA did not demonstrate the same pattern between treatments as trans 18:1, it is difficult to draw any firm conclusions regarding the effect of vitamin E on CLA from this trial.

The addition of safflower oil and flaxseed had the effect of reducing the level of 16:0 and 14:0 in the milk by on average 40.1% and 28.1% respectively (Table 8). This is very similar to what was observed in the previous feeding study. These two fatty acids are thought to have the ability to raise blood cholesterol when consumed in the diet so a large decrease in their concentration is an additional benefit. The concentration of the short to medium-chain fatty acids (4:0-15:0) were also reduced in milk as a result of safflower and flaxseed feeding as is typically observed when the dairy diet is supplemented with fats and oils.

Milk from each treatment group was collected on the third last and last day of weeks 0, 2, 4, and 8, processed, and compared by a panel of people trained in milk sensory evaluation. No difference was found between the six treatment groups for any sensory attribute on any of the weeks (data not shown). Vitamin E had been added in SAFF/E, SAFF/ME, and FLAX/E partly to protect against possible oxidation that might occur in milk with higher PUFA concentration. However, there did not appear to be any oxidation in any treatments, even after five days storage. Overall, the change in fatty acid composition appeared to have no effect on the sensory characteristics of the milk.

TABLE 5
Ingredient and chemical composition of experimental
diets.

| | Diet¹ | | | | | |
|---|---|---|---|---|---|---|
| | | | | SAFF/ | SAFF/ | FLAX/ |
| | CTL | SAFF | SAFF/E | M | M/E | E |
| Item | (% of DM) | | | | | |
| Ingredient | | | | | | |
| composition | | | | | | |
| Barley silage | 26.30 | 26.29 | 26.28 | 26.30 | 26.29 | 26.28 |
| Alfalfa silage | 21.20 | 21.19 | 21.19 | 21.20 | 21.19 | 21.19 |
| Alfalfa hay | 12.50 | 12.49 | 12.49 | 12.50 | 12.49 | 12.49 |
| Ground corn | 14.70 | 12.99 | 12.99 | 12.50 | 12.04 | 12.99 |
| Barley | 14.44 | 9.58 | 9.29 | 9.50 | 9.40 | 9.29 |
| Safflower oil | — | 6.00 | 6.00 | 6.00 | 6.00 | — |
| Flaxseed oil | — | — | — | — | — | 6.00 |
| Soybean meal | 5.00 | 5.00 | 5.00 | 5.00 | 5.20 | 5.00 |
| Canola meal | — | 2.00 | 2.00 | 2.00 | 2.00 | 2.00 |
| Corn gluten meal | 2.00 | 2.00 | 2.00 | 2.00 | 2.00 | 2.00 |
| Animal fat | 1.50 | — | — | — | 0.10 | — |
| Limestone | 0.60 | 0.60 | 0.60 | 0.60 | 0.60 | 0.60 |
| Dicalcium | 0.55 | 0.65 | 0.65 | 0.65 | 0.65 | 0.65 |
| phosphate | | | | | | |
| Mineral salt² | 0.40 | 0.40 | 0.40 | 0.40 | 0.40 | 0.40 |
| Salt | 0.30 | 0.30 | 0.30 | 0.30 | 0.30 | 0.30 |
| Magnesium oxide | 0.28 | 0.28 | 0.28 | 0.28 | 0.28 | 0.28 |
| Sodium bicarbonate | 0.15 | 0.15 | 0.15 | 0.15 | 0.15 | 0.15 |
| Vitamin ADE³ | 0.08 | 0.08 | 0.08 | 0.08 | 0.08 | 0.08 |
| Monensin⁴ | — | — | — | 0.54 | 0.54 | — |
| Vitamin E⁵ | — | — | 0.30 | — | 0.30 | 0.30 |
| Chemical | | | | | | |
| composition | | | | | | |
| DM, % | 43.9 | 44.1 | 44.0 | 43.8 | 43.5 | 44.4 |
| CP | 17.2 | 16.7 | 17.0 | 16.9 | 16.9 | 17.5 |
| Ether extract | 6.5 | 10.5 | 9.0 | 9.0 | 8.9 | 9.8 |
| NDF | 43.7 | 43.8 | 45.2 | 46.7 | 46.3 | 45.3 |
| ADF | 26.8 | 28.3 | 28.5 | 28.9 | 28.8 | 27.9 |
| Ash | 10.3 | 10.2 | 10.0 | 10.1 | 10.4 | 10.1 |
| NE_{L}⁶, Mcal/Kg | 1.71 | 1.88 | 1.87 | 1.87 | 1.87 | 1.87 |

¹Diets were control (CTL), and control supplemented with, safflower oil (SAFF), safflower oil plus vitamin E (SAFF/E), safflower oil plus monensin (SAFF/M), safflower oil plus monensin plus vitamin E (SAFF/M/E), or flaxseed plus vitamin E (FLAX/E).
²Contained: salt (min 95%), iodine (150 mg/kg), cobalt (50 mg/kg), copper (3500 mg/kg), manganese (10,000 mg/kg), zinc (9,000 mg/kg), and selenium (75 mg/kg).
³Contained: vitamin A (min 10,000,000 IU/kg), vitamin D (min 1,000,000 IU/kg), vitamin E (min 10,000 IU/kg).
⁴Contained: monensin (4,400 mg/kg).
⁵Contained: vitamin E (50,000 mg/kg).
⁶Estimated from NRC (1989)

TABLE 6
Fatty acid composition of safflower oil and flaxseed oil

| Fatty acid | Safflower oil | Flaxseed oil |
|---|---|---|
| 16:0 | 6.7 ± 0.57 | 5.6 ± 0.19 |
| 18:0 | 2.3 ± 0.22 | 4.0 ± 0.40 |
| 18:1n-9 | 14.8 ± 0.86 | 23.1 ± 1.28 |
| 18:2n-6 | 76.0 ± 0.24 | 21.3 ± 2.31 |
| 18:3n-6 | nd | 41.7 ± 2.63 |
| Other | 0.3 ± 0.17 | 4.3 ± 1.33 |

nd = not detected;
numbers represent averages ± standard deviation

TABLE 7
Dry matter intake (DMI), milk yield, and milk
composition during the treatment period,
independent of week.

| | Treatment¹ | | | | | | |
|---|---|---|---|---|---|---|---|
| | | | | SAFF/ | SAFF/ | FLAX/ | |
| | CTL | SAFF | SAFF/E | M | ME | E | Sem |
| DMI | 19.06 | 18.75 | 18.81 | 17.01 | 17.72 | 17.76 | 0.683 |
| kg/d | | | | | | | |
| Milk | 32.02 | 29.81 | 31.01 | 29.89 | 28.52 | 29.36 | 1.443 |
| yield | | | | | | | |
| kg/d | | | | | | | |
| Lactose | 4.60 | 4.60 | 4.63 | 4.56 | 4.53 | 4.62 | 0.051 |
| % | | | | | | | |
| Protein | 3.04 | 3.06 | 3.13 | 2.98 | 3.18 | 3.12 | 0.076 |
| % | | | | | | | |
| Fat % | 3.66^{a} | 2.97^{bc} | 3.26^{ab} | 2.85^{b} | 3.28^{ab} | 3.30^{ac} | 0.157 |
| Vitamin | 0.72^{a} | 0.81^{a} | 1.28^{b} | 0.83^{a} | 1.31^{b} | 0.87^{a} | 0.059 |
| E [symbol] g/g | | | | | | | |
| milk | | | | | | | |

¹Diets were control (CTL), and, control supplemented with: safflower oil (SAFF), safflower oil plus vitamin E (SAFF/E), safflower oil plus monensin (SAFF/M), safflower oil plus monensin plus vitamin E (SAFF/M/E), flaxseed plus vitamin E (FLAX/E).

TABLE 8
Milk fatty acid composition during the treatment
period, independent of week.

| | Treatments¹ | | | | | | |
|---|---|---|---|---|---|---|---|
| Fatty Acid | CTL | SAFF | SAFF/E | SAFF/M | SAFF/ME | FLAX/E | Sem |
| 4:0 | 4.12^{a} | 2.77^{b} | 3.04^{bc} | 2.81^{b} | 2.93^{bc} | 3.23^{c} | 0.131 |
| 6:0 | 2.37^{a} | 1.39^{b} | 1.54^{b} | 1.42^{b} | 1.50^{b} | 1.56^{b} | 0.071 |
| 8:0 | 1.19^{a} | 0.63^{a} | 0.70^{b} | 0.64^{b} | 0.68^{b} | 0.70^{b} | 0.039 |
| 10:0 | 2.53^{a} | 1.26^{b} | 1.40^{b} | 1.27^{b} | 1.38^{b} | 1.38^{b} | 0.082 |
| 11:0 | 0.343^{a} | 0.136^{b} | 0.167^{cd} | 0.140^{bd} | 0.161^{bc} | 0.185^{c} | 0.010 |
| 12:0 | 2.87^{a} | 1.53^{b} | 1.67^{b} | 1.55^{b} | 1.64^{b} | 1.64^{b} | 0.086 |
| 13:0 | 0.20^{a} | 0.10^{b} | 0.13^{b} | 0.11^{b} | 0.12^{b} | 0.12^{b} | 0.008 |
| 14:0 | 11.64^{a} | 8.10^{b} | 8.48^{b} | 8.32^{b} | 8.44^{b} | 8.48^{b} | 0.244 |
| 14:1 | 0.95^{a} | 0.57^{b} | 0.62^{b} | 0.54^{b} | 0.57^{b} | 0.60^{b} | 0.048 |
| 15:0 | 1.08^{a} | 0.74^{b} | 0.76^{b} | 0.78^{b} | 0.78^{b} | 0.79^{b} | 0.019 |
| 16:0 | 30.60^{a} | 18.70^{b} | 18.35^{b} | 17.99^{b} | 18.71^{b} | 17.87^{b} | 0.539 |
| 16:1 | 1.53^{a} | 0.96^{b} | 0.95^{b} | 0.90^{b} | 0.96^{b} | 0.91^{b} | 0.054 |
| 18:0 | 9.76^{a} | 11.43^{bc} | 11.63^{bd} | 10.30^{ac} | 10.51^{acd} | 11.08^{bc} | 0.411 |
| 18:1 trans | 2.63^{a} | 14.25^{b} | 13.10^{b} | 18.30^{c} | 16.26^{d} | 8.87^{e} | 0.577 |
| 18:1 n-9 | 19.26^{ab} | 21.14^{bc} | 21.79^{c} | 18.67^{a} | 19.48^{ab} | 24.00^{d} | 0.677 |
| 18:1 n-7 | 0.50 | 0.64 | 0.52 | 0.61 | 0.54 | 0.53 | 0.045 |
| 18:2 t-11, | 0.43^{a} | 0.57^{a} | 0.54^{a} | 0.55^{a} | 0.52^{a} | 2.99^{b} | 0.080 |
| c-15 | | | | | | | |
| 18:2 n-6 | 1.75^{a} | 2.89^{b} | 2.82^{b} | 2.96^{b} | 2.81^{b} | 2.01^{c} | 0.081 |
| 18:3 n-3 | 0.41^{a} | 0.32^{b} | 0.33^{b} | 0.32^{b} | 0.32^{b} | 0.73^{c} | 0.013 |
| 20:0 | 0.20^{a} | 0.17^{a} | 0.18^{a} | 0.16^{a} | 0.17^{a} | 0.53^{b} | 0.015 |
| 20:1 n12 | 0.17^{a} | 0.13^{b} | 0.13^{b} | 0.12^{b} | 0.12^{b} | 0.18^{a} | 0.006 |
| 20:1 n-9 | 0.07^{a} | 0.09^{b} | 0.08^{ab} | 0.11^{c} | 0.10^{bc} | 0.24^{d} | 0.006 |
| CLA c-9, t-11 | 0.68^{a} | 4.12^{bc} | 3.48^{bd} | 4.55^{c} | 4.75^{c} | 2.80^{d} | 0.308 |
| CLA t-10, | nd^{a} | 0.04^{a} | 0.06^{bc} | 0.09^{c} | 0.06^{bc} | nd^{a} | 0.013 |
| c-12 | | | | | | | |
| Other FA | 4.70^{a} | 7.28^{b} | 7.47^{b} | 6.78^{c} | 6.43^{d} | 8.51^{e} | 0.123 |

¹Diets were control (CTL), and, control supplemented with: safflower oil (SAFF), safflower oil plus vitamin E (SAFF/E), safflower oil plus monensin (SAFF/M), safflower oil plus monensin plus vitamin E (SAFF/MIE), flaxseed plus vitamin E (FLAX/E).

It is understood that the invention is not confined to the particular construction and arrangement of parts herein illustrated and described, but embraces such modified forms thereof as come within the scope of the claims following the Bibliography.

### BIBLIOGRAPHY

1. Belbury, M. A. 1995. Conjugated dienoic linoleate: A polyunsaturated fatty acid with unique chemoprotective properties. Nutrition Reviews, Vol. 53, 4:83-89.

2. Chin, S. F., Liu, W., Storkson, J. M., Ha, Y. L., Pariza, M. W. 1992. Dietary sources of conjugated dienoic isomers of linoleic acid, a newly recognized class of anticarcinogens. J. Food Comp. Anal. 5:185-197.

3. Chouinard, P. Y., Corneau, L., Bauman, D. E., Butler, W. R., Chilliard, Y., Drackley, J. K. 1998. Conjugated linoleic acid content of milk from cows fed different sources of dietary fat. J. Animal Sci. Vol. 76, Suppl. 1; J. Dairy Sci. Vol. 81, Suppl. 1:1998 (Abstract).

4. Cook, M. E., Miller, C. C., Park, Y., Pariza, M. W. 1993. Immune modulation by altered nutrient metabolisms: nutritional control of immune-induced growth depression, Poultry Science, 72:1301-1305.

5. Corl, B. A., Chouinard, P. Y., Bauman, D. E., Dwyer, D. A., Griinari, J. M., Nurmella, K. V. 1998. Conjugated linoleic acid in milk fat of dairy cows originates in part by endogenous synthesis from trans-11 octadecenoic acid. J. Anim. Sci. 76, Suppl. 1; J. Dairy Sci. Vol. 81, Suppl. 1:1998, Page 233.

6. Dhiman, T. R., Anand, G. R., Satter, L. D., Pariza, M. W. 1999. Conjugated linoleic acid content of milk from cows fed different diets. J. Dairy Sci. 82:2146-2156.

7. Dipple, A. Formation, metabolism, and mechanism of action of polycyclic aromatic hydrocarbons. Cancer Research. 43:2422s-2425s, 1983.

8. Fellner. V., Sauer, F. D., Kramer, J. K. G. Effect of Nigericin, Monensin, and Tetronacin on biohydrogenation in continuous flow-through rumenal fermenters, J. Dairy Sci., 80:921-928, 1997.

9. Griinari, J. M. 1998. Trans fatty acids in milk: health risk or a benefit. J. Animal Sci. Vol. 76, Suppl. 1; J. Dairy Sci. Vol 81, Suppl. 1;1998, Page 236 (Abstract).

10. Griinari. J. M., Bauman, D. E. 1999. Biosynthesis of conjugated linoleic acid and its incorporation into meat and milk of ruminants. In: Advances in Conjugated Linoleic Acid Research, Volume 1, Chapter 13, pages 180-200.

11. Griinari, J. M., Chouinard, P. Y., Bauman, D. E. 1997. Trans fatty acid hypothesis of milk fat depression revised. Proceedings Cornell Nutr. Conf. Feed Manuf., Pages 208-216. 59^{th} Cornell Nutrition Conference, Ithaca, N.Y., 1997.

12. Griinari, J. M., Dwyer, D. A., McGuire, M. A., Bauman, D. E., Palmquist, D. L., Nurmela, K. V. V. 1998 Trans-octadecanoic acids and milk fat depression in lactating dairy cows. J. Dairy Sci. 81:1251-1261.

13. Ha, Y. L., Grimm, N. K., Pariza, M. W. 1987. Anticarcinogens from fried ground beef: heat-altered derivatives of linoleic acid. Carcinogenesis. Vol. 8, 12:1881-1887.

14. Houseknecht, K. L., Vanden Heuvel, J. P., Moya-Camarena, S. Y., Portocarrerro, C. P., Peck, L. W., Nickel, K. P., Belury, M. A. 1998. Conjugated linoleic acid normalizes impaired gluco tolerance in the Zucker diabetic fatty fa/fa rat. Biochem. Biophys. Res. Commun. 244:678-682.

15. Ip, C. 1994. Conjugated linoleic acid in cancer prevention research: A report of current status and issues. A special report prepared for the National Livestock and Meat Board. May, 1994.

16. Ip, C., Singh, M., Thompson, H. J., Scimeca, J. M. 1994. Conjugated linoleic acid suppresses carcinogenesis and proliferative activity of the mammary gland in the rat. Cancer Research, 54:1212.

17. Ip, C., Banni, S., Angioni, E., Carta, G., McGinley, J., Thompson, H., Barbano, D., Bauman, D. 1999 Journal of Nutrition 129:2135-2142.

18. Kelly, M. L., Bauman, D. E. 1996. Conjugated linoleic acid: A potent anticarcinogenin found in milk fat. Proceedings Cornell Nutr. Conf. Feed Manuf., Pages 68-74. 58^{th} Cornell Nutrition Conference, Ithaca, N.Y., 1996.

19. Kelly, M. L., Berry, J. R., Dwyer, D. A., Griinari, J. M., Chouinard, P. Y., Van Amburgh, M. E., Bauman, D. E. 1998. Dietary fatty acid sources affect conjugated linoleic acid concentrations in milk from lactating dairy cows. Journal of Nutrition 128:881-885.

20. Kepler, C. R., Tove, S. B. 1967 Biohydrogenation of unsaturated fatty acid. J. Biol. Chem. 242:5686-5692.

21. Knekt, P., Jarvinen, R., Seppanen, R., Pukkala, E., Aromaa, A. 1996. Intake of dairy products and the risk of cancer. Brit. J. Cancer 73:687-691.

22. Lee, K. N., Kritchevsky, D., Pariza, M. W. 1994. Conjugated linoleic acid and atherosclerosis in rabbits. Atherosclerosis 108:19-25.

23. Lin, H., Boylston, T. D., Chang, M. J., Luedecke, L. O., Schultz, T. D. 1995. Survey of conjugated linoleic acid contents of dairy products. J. Dairy Sci. 78:2358-2365.

24. McGuire, M. A., McGuire, M. K. 1997. Bovinic acid: the natural CLA. Proceedings Cornell Nutr. Conf. Feed Manuf., Pages 217-226. 59^{th} Cornell Nutrition Conference, Ithaca, N.Y., 1997.

25. McGuire, M. A., McGuire, M. K., Guy, M. A., Sanchez, W. K., Schultz, T. D., Harrison, L. Y., Bauman, D. E., Griinari, J. M. 1996. Short-term effect of dietary lipid concentration on content of conjugated linoleic acid (CLA) in milk from dairy cattle. J. Animal Sci. 74:266, Suppl.1, 1996 (Abstract).

26. Nicolosi, R. J., Rogers, E. J., Kritchevsky, D., Scimeca, J. A., Huth, P. J. 1997. Dietary conjugated linoleic acid reduces plasma lipoproteins and early aortic atherosclerosis in hypercholesterolemic hamsters. Artery 22:266-277.

27. Pariza, M. W., Ashoor, S. H., Chu, F. S., Lund, D. B. 1979. Effects of temperature and time on mutagen formation in pan-fried hamburger. Cancer Letters, 7:63-69.

28. Pariza, M. W., Hargreaves, W. A. 1985. A beef-derived mutagenesis modulator inhibits initiation of mouse epidermal tumors by 7,12-dimethylbenz[a]anthrazene. Carcinogenesis Vol. 6, 4:591-593.

29. Park, Y., Albright, K. J., Liu, W., Storkson, J. M., Cook, M. E., Pariza, M. W. 1997. Effects of conjugated linoleic acid on body composition in mice. Lipids, 32:853-858.

30. Parodi, P. W. 1997. Cow=s milk fat components as potential anticarcinogenic agents. Journal of Nutrition. 127:1055-1060.

31. Salminen, I. M., Mutanen, M., Jauhiainen, M., Aro, A. 1998. Dietary trans fatty acids increase conjugated linoleic acid levels in human serum. J. Nutr. Biochem. 9:93-98.

32. Sauer, F. D., Fellner, V., Kinsman, R., Kramer, J. K. G., Jackson, H. A., Lee, H. J., and Chen, S. 1998. Methane output and lactation response in Holstein cattle with monensin or unsaturated fat added to the diet, J. Animal Sci., 76:906-914.

33. Shantha, N. C., Crum, A. D., Decker, E. A. 1994. Evaluation of conjugated linoleic acid concentrations in cooked beef. J. Agric. Food Chem., 42:1757-1760.

34. Shantha, N. C., Lam, L. N., O=Leary, J., Hicks, C. L., Decker, E. A. 1995. Conjugated linoleic acid concentrations in dairy products as affected by processing and storage. J. Food Sci., 60:695-697.

35. Shultz, T. D., Chew, B. P., Seaman, W. R. 1992a. Differential stimulatory and inhibitory responses of human MCF-7 breast cancer cells to linoleic acid and conjugated linoleic acid in culture. Anticancer Research, 12:2143-2146.

36. Shultz, T. D., Chew, B. P., Seaman, W. R., Luedecke, L. O. 1992b Inhibitory effect of conjugated dienoic derivatives of linoleic acid and carotene on the invitro growth of human cancer cells. Cancer Letters, 63:125-133.

37. Visonneau, S. Cesano, A., Tepper, S. A., Scemeca, J., Kritchevsky, D. 1996. Effect of different concentrations of conjugated linoleic acid (CLA) on tumor cell growth in vitro. FASEB J. 9:A869.

38. Wakabayashi, K., Nagao, M., Esumi, H., Sugimura, T. 1992. Food derived mutagens and carcinogens. Cancer Research. 52:2093s-2098s.

39. Watkins, B. A., Li, Y., Seifert, M. F. 1999. Bone Metabolism and Dietary Conjugated Linoleic Acid. In: Advances in Conjugated Linoleic Acid Research, Volume 1. Chapter 25, Pages 327-339.

40. Sutton, J. D. 1989. Altering milk composition by feeding. J. Dairy Sci. 72:2801-2814.

41. Wattenberg, L. W. 1992. Inhibition of carcinogenesis by minor dietary constituents. Cancer Research (Suppl.) 52:2085-2091.

42. Willet, W. C., Stamper, M. J., Manson, J. E., Colditz, G. A., Speizer, F. E., Rosner, B. A., Sampson, L. A., Hennekens, C. H. 1993. Vol.341, March, 6, Pages 581-585.

43. Yoon, C. S., Ha, T. Y., Rho, J. H., Sung, J. H., Cho, I. J. 1997. Inhibitory effect of conjugated linoleic acid on in vitro growth of human hepatoma. FASEB J. 11:A578.

What is claimed is:

1. A method for increasing concentrations of conjugated linoleic acid isomers in milk fat and/or tissue fat of ruminants, the method comprising:
feeding a ruminant an amount of a feed formulation comprising a combination of
a vegetable oil selected from the group consisting of vegetable oils containing at least 50% C18:2, at least 30% C18:3, and mixtures thereof, and
an ionophore that inhibits growth of gram positive bacteria in a rumen; and wherein
the amount of the feed formulation is effective to increase concentrations of conjugated linoleic acid isomers in the milk fat and/or tissue fat of ruminants.

2. The method of claim 1, wherein the ruminant is fed a feed formulation wherein the vegetable oil comprises safflower oil and the ionophore comprises monensin.

3. The method of claim 2, wherein the ruminant is fed a feed formulation comprising, on a dry weight percent basis of total dietary matter, from about 2% to about 7% safflower oil.

4. The method of claim 2, wherein the ruminant is fed a feed formulation comprising, on a dry weight percent basis of total dietary matter, about 6%-safflower oil.

5. The method of claim 1, wherein the feed formulation further comprises, in combination, forage.

6. The method of claim 1, wherein the ruminant is fed a feed formulation wherein the vegetable oil comprises safflower oil and the ionophore comprises monensin, and further comprising, prior to feeding the ruminant, mixing the safflower oil and the monensin together to yield a homogeneous mixture, and then adding the mixture to a non-forage component of a total mixed ration.

7. A method for increasing concentrations of conjugated linoleic acid isomers in milk fat of ruminants, the method comprising:
feeding a ruminant an amount of a feed formulation comprising a combination of safflower oil and monensin, wherein the amount of the feed formulation is effective to increase the concentrations of conjugated linoleic acid isomers in the milk fat of ruminants.

8. The method of claim 7, wherein the safflower oil is present in the feed formulation in an amount between about 2% and 7% by weight of dietary dry matter fed to the ruminant.

9. An animal feed formulation comprising: a combination of
a vegetable oil selected from the group consisting of vegetable oils containing at least 50% C18:2, at least 30% C18:3, and mixtures thereof, and
an ionophore that inhibits growth of gram positive bacteria in a rumen; wherein
the combination is present in the feed formulation in an amount effective to increase concentrations of conjugated linoleic acid isomers in milk fat of ruminants when the feed formulation is fed to a ruminant.

10. The animal feed formulation of claim 9, wherein the vegetable oil comprises safflower oil.

11. The animal feed formulation of claim 9, wherein the ionophore comprises monensin.

12. The animal feed formulation of claim 9, wherein the vegetable oil comprises safflower oil, and the ionophore comprises monensin.

13. The animal feed formulation of claim 9, further comprising, in combination, forage.

14. An animal feed formulation comprising: a combination of safflower oil and monensin, the combination present in the feed formulation in an amount effective to increase concentrations of conjugated linoleic acid isomers in milk fat of ruminants when the feed formulation is fed to a ruminant.

15. The animal feed formulation of claim 14, further comprising, in combination, forage material selected from the group consisting of alfalfa hay, alfalfa silage, small grain silage, grass, hay, and combinations thereof.

16. The animal feed formulation of claim 14, further comprising, in combination, corn, barley, oats, sorghum, wheat, bran, hominy, soybean meal, canola meal, bloodmeal, corn gluten, vitamins, minerals, and combinations thereof.

17. The animal feed formulation of claim 14, wherein the safflower oil is present in an amount between about 2% and 7% by weight of dietary dry matter fed to the ruminant.

18. The animal feed formulation of claim 14, wherein safflower oil is present in an amount of about 6% by weight of dietary dry matter fed to the ruminant.
